(19) United States
(12) Patent Application Publication
(10) Pub. No.: US 2004/0193444 A1
(43) Pub. Date: Sep. 30, 2004

(54) Computer system for managing litigation risk early warning system

(76) Inventors: Wendy Hufford, Rye, NY (US); Bernadette L. Savage, Stamford, CT (US); Eva Willatt, Norwalk, CT (US)

Correspondence Address: BUCKLEY, MASCHOFF, TALWALKAR LLC, 5 ELM STREET, NEW CANAAN, CT, 06840, US

(21) Appl. No.: 10/824,154

(22) Filed: Apr. 14, 2004

Related U.S. Application Data
(63) Continuation-in-part of application No. 09/645,065, filed on Aug. 24, 2000.
(60) Provisional application No. 60/173,248, filed on Dec. 28, 1999.

(51) Int. Cl. G06F 7/00

(52) U.S. Cl. 705/1

(57) ABSTRACT

A computer system includes a server computer, a plurality of client computers and a communication network that interconnects the server computer and the client computers. A first user of the computer system publishes a notification of a potential legal issue in the computer system and directs the notification to a second user. The notification is stored in a web page that is accessible to the second user. The second user accesses the web page and publishes a response to the notification. The response indicates whether a warning notice regarding the potential issue is warranted. Computer-based forms facilitate the preparation of the notification and the response. Menus in the forms facilitate the assignment of notification to the second user and the indication as to whether a warning notice is warranted.

### CROSS-REFERENCE TO RELATED APPLICATIONS

This application is a continuation-in-part of U.S. Non-provisional patent application Ser. No. 09/645,065, filed Aug. 24, 2000, entitled “Method and System for a Comprehensive Litigation Early Warning System”, and incorporated herein by reference, which claims the benefit of U.S. Provisional Application serial No. 60/173,248 filed on Dec. 28, 1999. The '248 Provisional Application is also incorporated herein by reference.

### FIELD

The present invention relates to computer systems, and more particularly to a computer system that facilitates management of a corporation's legal affairs.

### BACKGROUND

It is an oft-stated goal of legal counsel, and particularly in-house counsel, to provide “preventive” legal services, i.e., to advise clients of potential legal issues in such a way as to prevent or minimize exposure to litigation. However, achieving this goal can be elusive, since it can be difficult to receive, manage and act upon information concerning potential legal risks. A particular problem arises in connection with the profusion of information that practicing attorneys typically receive concerning new legal developments. Newsletters, advance sheets and updates from outside counsel usually contain much information that is irrelevant to a particular corporation's business. Such documents are often relegated to the bottom of an in-box, and any relevant issues may escape attention. A system is needed that identifies potential legal risks in a specific, user-friendly way that facilitates evaluation of new issues and preventive action when required.

### SUMMARY

To alleviate problems inherent in the prior art, the present invention introduces improved computer systems and methods for operating computer systems to facilitate receipt and handling of information relating to potential legal issues.

According to one embodiment, a computer system includes a server computer and a plurality of client computers. Each of the client computers includes a respective display device, a respective pointing device and a respective keyboard. The computer system also includes a communication network coupled to the server computer and to the client computers to permit data communication among the server computer and the client computers. The server computer and the client computers are programmed such that (a) a first user at a first one of the client computers is permitted to use the respective pointing device of the first one of the client computers to actuate a first actuatable option on a first screen display to access a second screen display. The second screen display includes a first form that is completeable by the first user to provide a notification of a potential legal issue. The first form includes a first menu that is actuatable by the respective pointing device of the first one of the client computers to select from among a plurality of options presented by the first menu. Each of the plurality of options corresponds to a respective potential recipient of the notification of the potential legal issue. The server computer and the client computers are further programmed such that (b) upon the first user electing to publish the notification of the potential legal issue, an electronic mail message is automatically dispatched to the respective potential recipient who corresponds to a one of the plurality of options selected by the first user in completing the form. The respective potential recipient is a second user of the computer system. The server computer and the client computers are further programmed such that (c) the second user is permitted to retrieve the electronic mail message and to display the retrieved electronic mail message on the respective display device of a second one of the client computers. The displayed electronic mail message indicates to the second user that the notification has been published and that the notification has been directed to the second user. The server computer and the client computers are further programmed such that (d) the second user is permitted to use the respective pointing device of the second one of the client computers to actuate a second actuatable option on at least one of the first screen display and a third screen display to access a fourth screen display. The fourth screen display is for providing to the second user information concerning the potential legal issue as to which the first user provided notification. The server computer and the client computers are further programmed such that (e) the second user is permitted to use the respective pointing device of the second one of the client computers to actuate a third actuatable option on at least one of the first screen display and a fifth screen display to access a sixth screen display. The sixth screen display includes a second form to provide a response to the notification of the potential legal issue provided by the first user. The second form includes a second menu that includes an early warning menu option selectable by using the respective pointing device of the second one of the client computers to indicate that a warning notice concerning the potential legal issue is to be provided to a plurality of users other than the first and second users.

According to another embodiment, a computer system includes a server computer and a plurality of client computers. Each of the client computers includes a respective display device, a respective pointing device and a respective keyboard. The computer system also includes a communication network coupled to the server computer and to the client computers to permit data communication among the server computer and the client computers. The server computer and the client computers are programmed such that at least some of the client computers display, in response to respective requests from users, at least the following screen displays:

(a) a welcome screen display that includes a confidentiality and privilege notice and which provides an overview of an early warning system for potential legal issues;

(b) a potential issues room screen display that allows a user access to other screen displays which provide information concerning potential legal issues;

(c) a request folder screen display that lists at least one notification of a potential legal issue;

(d) a request form screen display that is completeable by using at least one of a keyboard and a pointing device to publish a notification of a potential legal issue;

(e) a plurality of subject area room screen displays, each corresponding to a respective area of responsibility within a corporation that operates the computer system and each displaying at least one line of information concerning a potential legal issue related to the respective area of responsibility;

(f) a response folder screen display that lists at least one response to a notification of a potential legal issue; and

(g) a response form screen display that is completeable by using at least one of a keyboard and a pointing device to publish a response to a notification of a potential legal issue.

According to still another embodiment, a method of operating a computer system includes navigating from a first screen display to a second screen display. The second screen display includes a first form that is completeable by a first user of the computer system to provide a notification of a potential legal issue. The first form includes a first menu that is actuatable by a pointing device to select among a plurality of options presented by the first menu. Each of the plurality of options corresponds to a respective potential recipient of the notification of the potential legal issue. The method also includes publishing the notification of the potential legal issue to at least one other user of the computer system. The method further includes, in response to publishing the notification, automatically sending an electronic mail message to a second user of the computer system. The second user is the respective potential recipient who corresponds to a one of the plurality of options selected by the first user in completing the first form.

According to yet another embodiment, a method of operating a computer system includes navigating from a first screen display to a second screen display. The second screen display includes a first form that is completeable by a first user of the computer system to provide a notification of a potential legal issue. The first form includes a first menu that is actuatable by a pointing device to select among a plurality of options presented by the first menu. Each of the plurality of options corresponds to a respective potential recipient of the notification of the potential legal issue. The method also includes publishing the notification of the potential legal issue to at least one other user of the computer system. The method further includes, in response to publishing the notification, storing the notification at a web page associated with the second user. The method also includes the second user accessing the web page associated with the second user to access the published notification.

As used herein and in the appended claims, “pointing device” includes a computer mouse, a track ball, a touch pad, and any other device that may be used to move a cursor on a computer display screen.

As used herein and in the appended claims, “publishing” a document in a computer system refers to making the document available to at least one user of the computer system other than the author of the document.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram of a computer system according to some embodiments.

FIG. 2 is a block diagram of a server computer that is part of the computer system of FIG. 1.

FIG. 3 is a block diagram of a typical one of the client computers that are part of the computer system of FIG. 1.

FIG. 4 is a flow chart that illustrates a process performed according to some embodiments to bring a potential legal issue up for evaluation.

FIGS. 5-8 are examples of screen displays that may be displayed by one of the client computers of the computer system of FIG. 1 in connection with the process illustrated in FIG. 4.

FIGS. 9A to 9C together form a flow chart that illustrates a process performed according to some embodiments to evaluate and respond to a potential legal issue.

FIGS. 10-12 are examples of screen displays that may be displayed by one of the client computers of the computer system of FIG. 1 in connection with the process illustrated in FIGS. 9A and 9B.

FIGS. 13 and 14 are examples of screen displays that may be displayed by one of the client computers of the computer system of FIG. 1 in connection with a user of the system accessing a memorandum stored in the system.

### DETAILED DESCRIPTION

System Overview

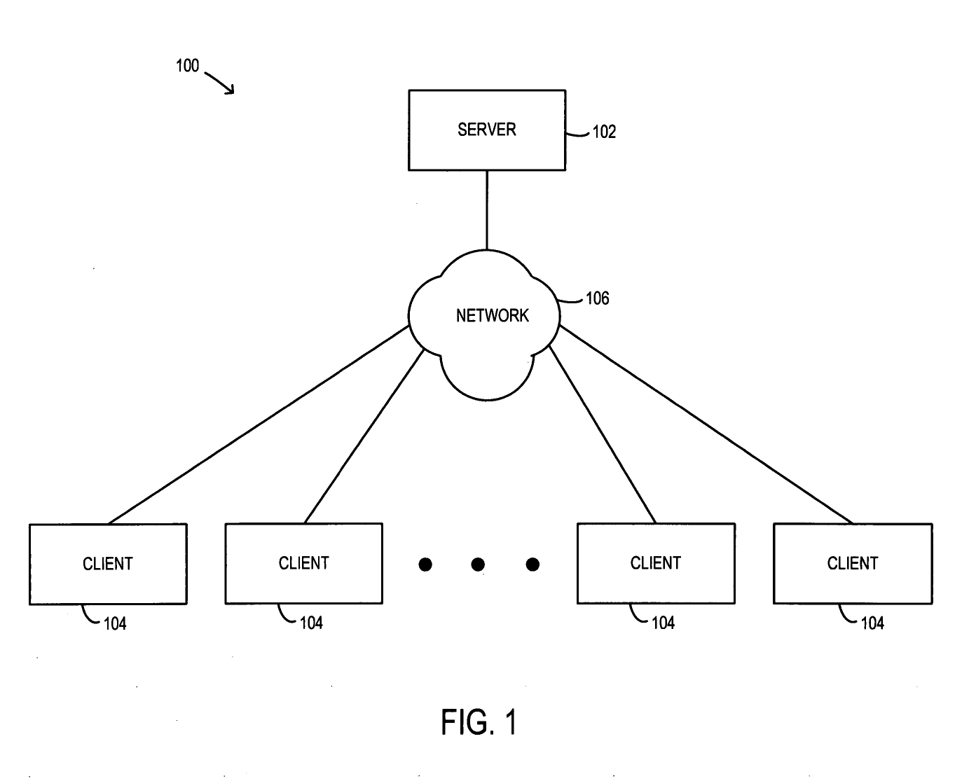

Turning now in detail to the drawings, FIG. 1 is a computer system provided according to some embodiments of the present invention. In FIG. 1, reference numeral 100 generally indicates the computer system. The computer system 100 includes a server computer 102 and a number of client computers 104. The computer system 100 also includes data communication network 106 which is coupled to the server computer 102 and to the client computers 104 to permit data communication to occur among the server computer 102 and the client computers 104. In some embodiments, the data communication network 106 may be implemented as an intranet, an extranet or a combination of intranet and extranet. In some embodiments, communication over the data communication network 106 may be performed in accordance with the well-known Internet Protocol (IP). The data communication network 106 may be physically realized with any one or more of a public network, a private network, dial-up lines or any combination thereof.

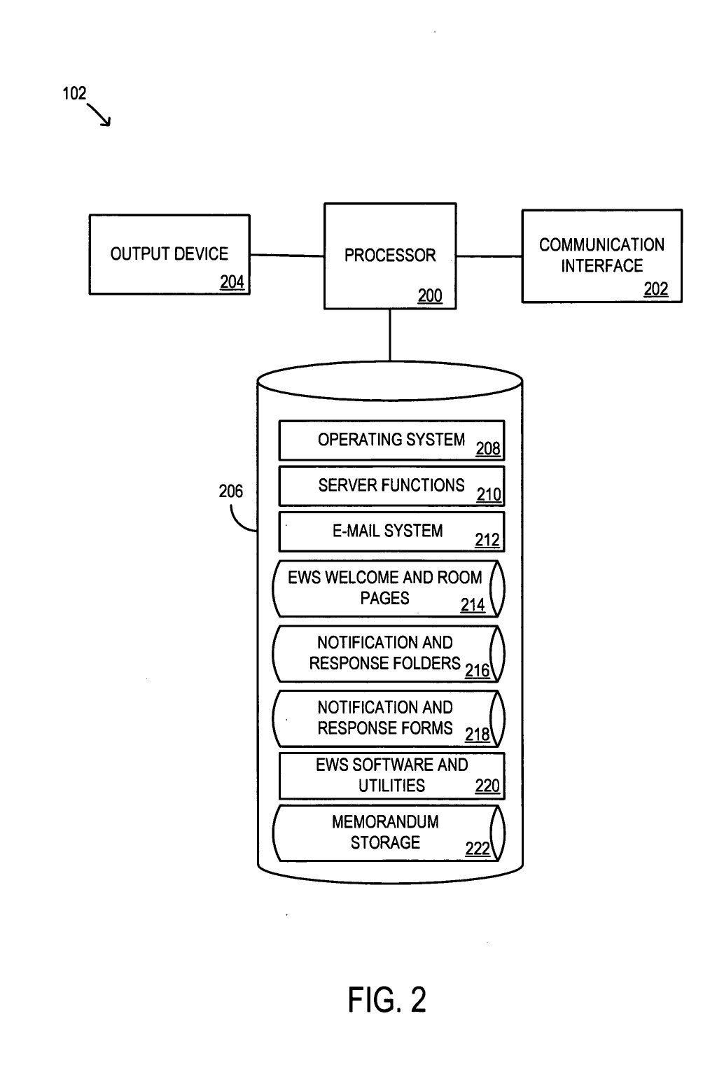

FIG. 2 is a block diagram which shows some details of the server computer 102. In its hardware aspects, the server computer 102 may be entirely conventional, or may be constructed of standard hardware components developed in the future. The server computer 102 includes a processor 200, which may be a conventional microprocessor, or a number of processors operating in parallel. The processor 200 is in data communication with a communication interface 202 coupled to the data communication network 106 (FIG. 1). Continuing to refer to FIG. 2, the server computer 102 communicates with other components of the computer system 100, including the client computers 104, through the communication interface 202. The processor 200 is also in data communication with one or more output device(s) 204, which may include one or more displays and/or printers. (Although not shown in the drawing, the server computer 102 may also include one or more input devices, such as keyboards and mice, in data communication with the processor 200.)

Also included in the server computer 102 is a storage device 206, such as a conventional hard disk drive or group of hard drives, in data communication with the processor 200. The storage device 206 stores programs and data which are provided in accordance with the invention to control the processor 200 so that the computer system 100 operates in accordance with one or more aspects of the present invention. In particular, the storage device 206 stores an operating system 208 which controls the processor 200 to perform basic functions of the server computer 102. In addition, the storage device 206 stores server functions software 210 which controls the processor 200 so that the server computer 102 functions as a server in communication with the client computers 104 (FIG. 1).

Continuing to refer to FIG. 2, the storage device 206 further stores electronic mail system software 212 so that the server computer functions as a clearing house to provide for electronic mail communication among the client computers 104.

The operating system, server functions and e-mail system software may all be provided substantially in accordance with conventional practices and/or in accordance with standard or custom software packages developed hereafter.

In accordance with some embodiments of the invention, the storage device 206 also stores a number of web pages 214 by which users of the client computers 104 are welcomed to, and are permitted to navigate among various rooms of, an early warning system (EWS) for potential litigation issues. Also, the storage device 206 stores folders 216 for storing documents created by users of the client computers 104 in connection with the EWS. These document may include notifications of potential legal issues and responses to the notifications.

Moreover, the storage device 206 may store web pages 218 that function as forms that may be completed by users of the client computers to author the above-mentioned notifications of potential legal issues and responses thereto. In addition, software and utilities 220 for operating the EWS (as described below) may be stored in the storage device 206. Finally, the storage device 206 may store memoranda 222 prepared by users of the client computers 104. The memoranda may be related to the legal issues that are the subjects of the notifications and the responses to the notifications.

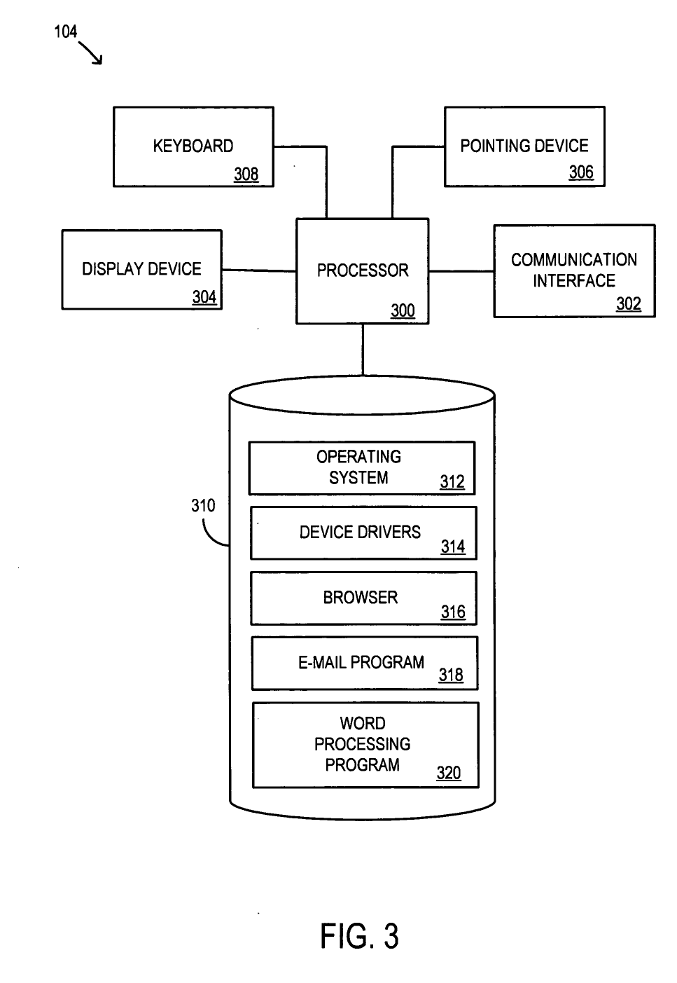

FIG. 3 is a block diagram of a typical one of the client computers 104 shown in FIG. 1. Each client computer 104 may be, in its hardware aspects, constituted in a conventional fashion as a desktop computer, a laptop computer or a notebook computer, for example. As seen from FIG. 3, the typical client computer 104 may include a processor 300 (e.g., a conventional microprocessor) and a communication interface 302 in communication with the processor 300. The communication interface 302 may allow the processor to communicate with other components of the computer system 100 (FIG. 1) such as the server computer 102 and other client computers.

Continuing to refer to FIG. 3, the client computer 104 also includes a display device 304 (e.g., a computer CRT monitor or a flat panel display) in communication with the processor 300, a pointing device 306 (e.g., a computer mouse, a track ball or a touch pad) in communication with the processor 300, and a keyboard 308 in communication with the processor 300. In addition, the client computer 104 includes a storage device 310, which may be a hard drive, for example.

The storage device 310 may store the following software: (a) an operating system 312, (b) device drivers 314 for controlling and/or receiving input from peripheral devices such as the communication interface 302, the display device 304, the pointing device 306 and the keyboard 308, (c) a browser 316 which allows the client computer 104 to operate as a client device relative to the server computer 102 (FIG. 1) and to access web pages and other server functions provided by the server computer, (d) client electronic mail software 318, and (e) a word processing program 320. In some embodiments, all of the software stored in the storage device 310 may be conventional, with all of the custom software and/or data required for the EWS resident on the server computer 102 and accessible via standard client software on the client computers 104.

In some embodiments, all of the client computers may be dedicated to users who are employees of a corporation that operates the EWS and the computer system 100. For example, the users may be restricted to in-house attorneys of the corporation, support staff for the attorneys who aid in operating the EWS, and managers of the corporation who receive legal advice from the in-house attorneys. It may be advisable to restrict the users to the individuals referred to in the previous sentence, so as to maintain the right of treating the contents of the EWS as subject to attorney/client privilege. Without losing such privilege, the group of users may be expanded, in some embodiments, to include outside counsel, and in such embodiments some of the client computers may be located in the offices of the outside counsel and may be dedicated to the use of the outside counsel and their support staff.

The server computer 102 may, but need not, be located on premises controlled by the corporation. In some embodiments, the server computer may be maintained on the premises of a contractor who provides web hosting and/or other services to the corporation, with the understanding that access to the EWS functions of the server computer 102 are limited as indicated in the preceding paragraph. In some embodiments, the computer system 100 and/or some or all of its components may also be used for purposes other than the EWS. To give only one example, the electronic mail system that operates on the computer system 100 may be used for messaging that has nothing to do with the EWS, in addition to being used in connection with the EWS.

EWS Functionality

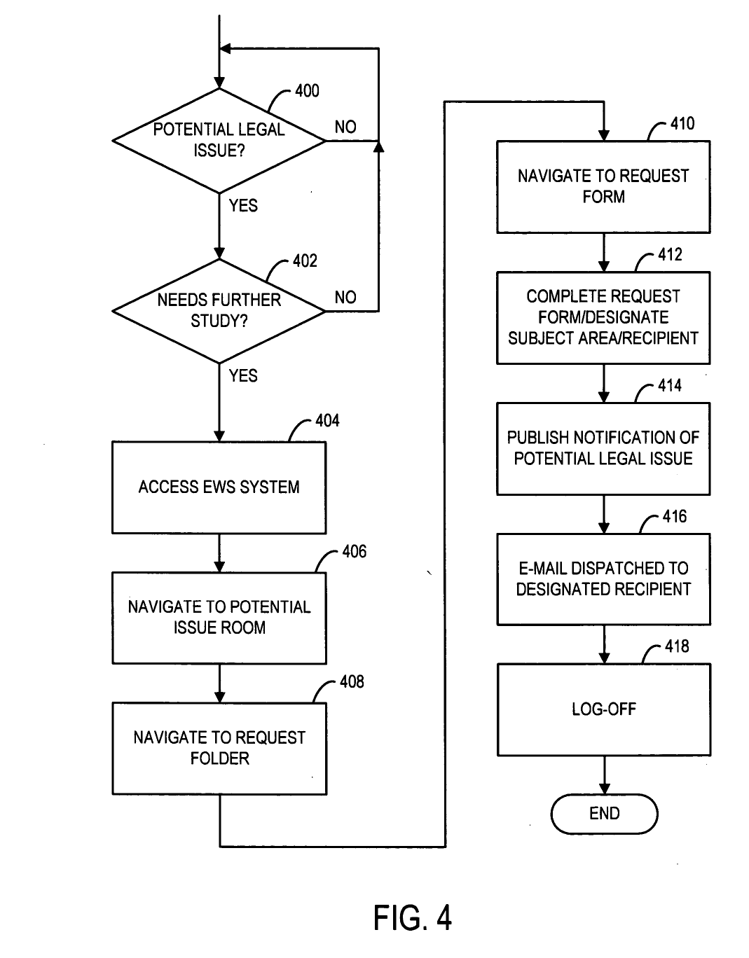

FIG. 4 is a flow chart that illustrates a process performed according to some embodiments to bring a potential legal issue up for evaluation in the EWS.

At 400 in FIG. 4 is a decision block at which it is determined whether a potential legal issue has come to the attention of a user of the system. The potential legal issue may come up as a result of one or more of newly enacted legislation, new regulations, a court decision or new interpretation of existing laws or regulations, or the bringing of a lawsuit or claim against another corporation or against the corporation which operates the computer system 100.

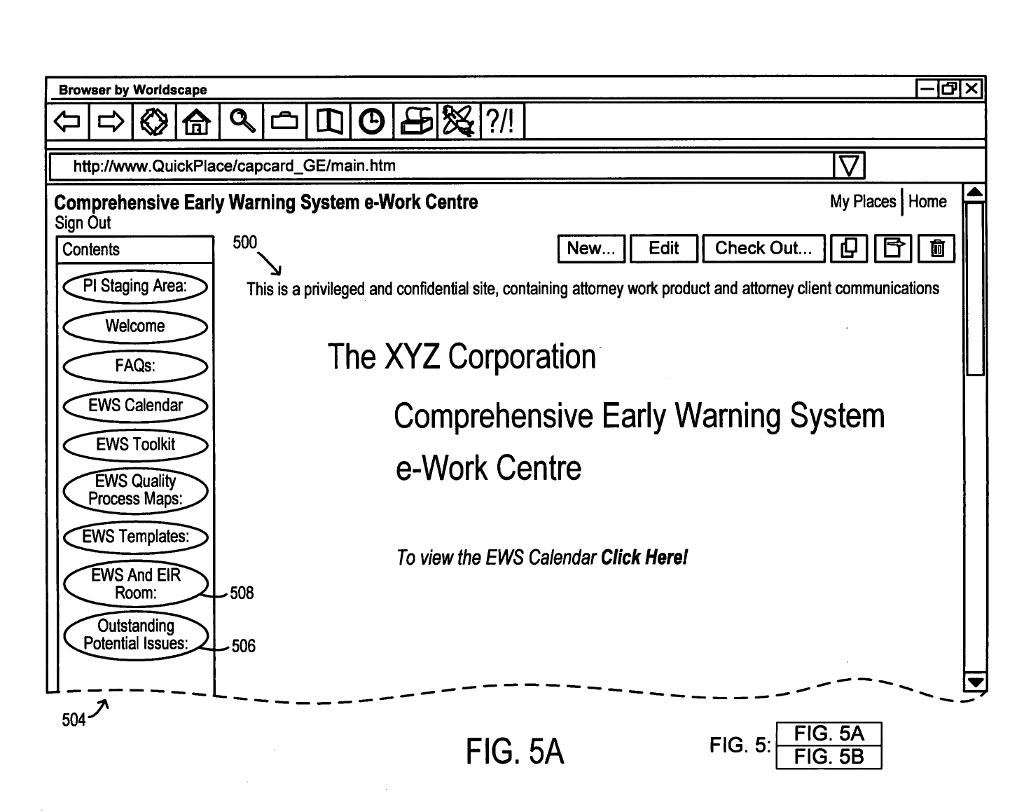

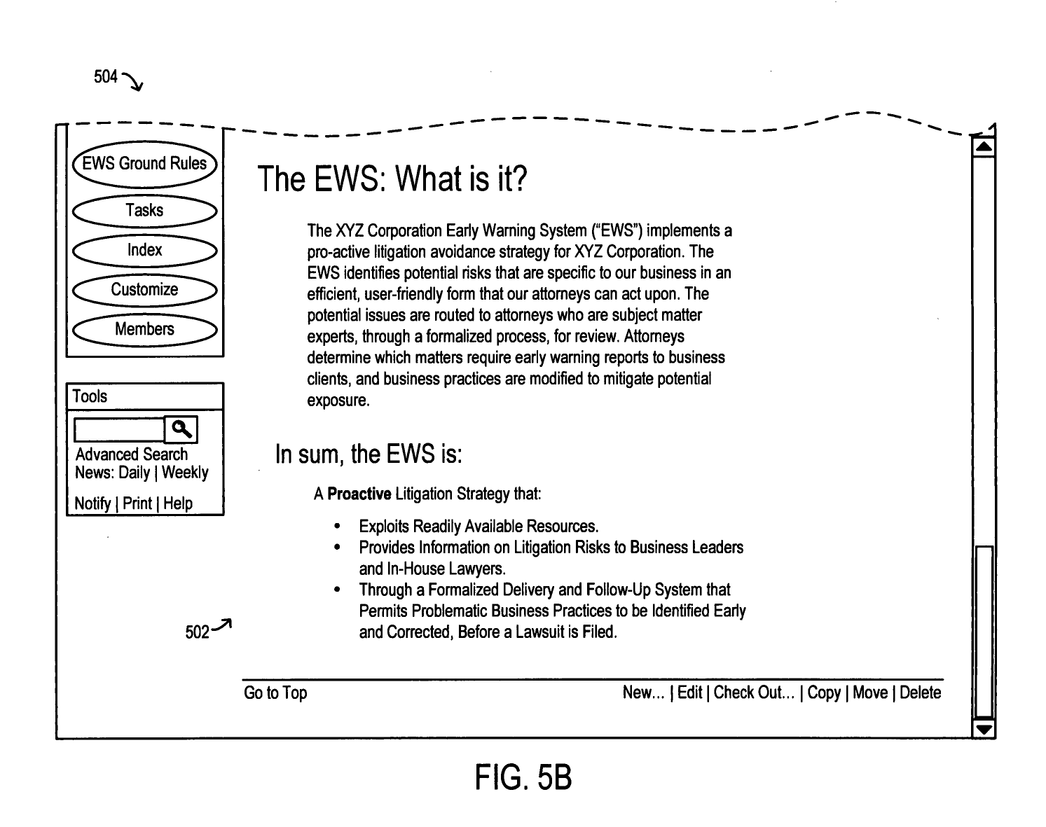

If at 400 no potential legal issue is found to have arisen, the process idles. However, if a potential legal issue is found, it is determined, at a decision block 402, whether the potential legal issue merits further study. If such is not the case, the process returns to an idle condition, but if further study of the potential legal issue is merited, then a first user uses a first one of the client computers 104 to access the EWS, as indicated at block 404. Access to the EWS may be password-controlled, for example, and/or other security features may also be employed to control access to the EWS. Upon grant of access to the EWS, the client computer used by the first user may display a “welcome” screen display like the screen display shown in FIG. 5 (which is formed from FIGS. 5A and 5B). The screen display may include a confidentiality and privilege notice, as indicated at 500 in FIG. 5A, and may also include a brief overview of the nature of the EWS. The overview may be presented in text shown at 502 in FIG. 5B.

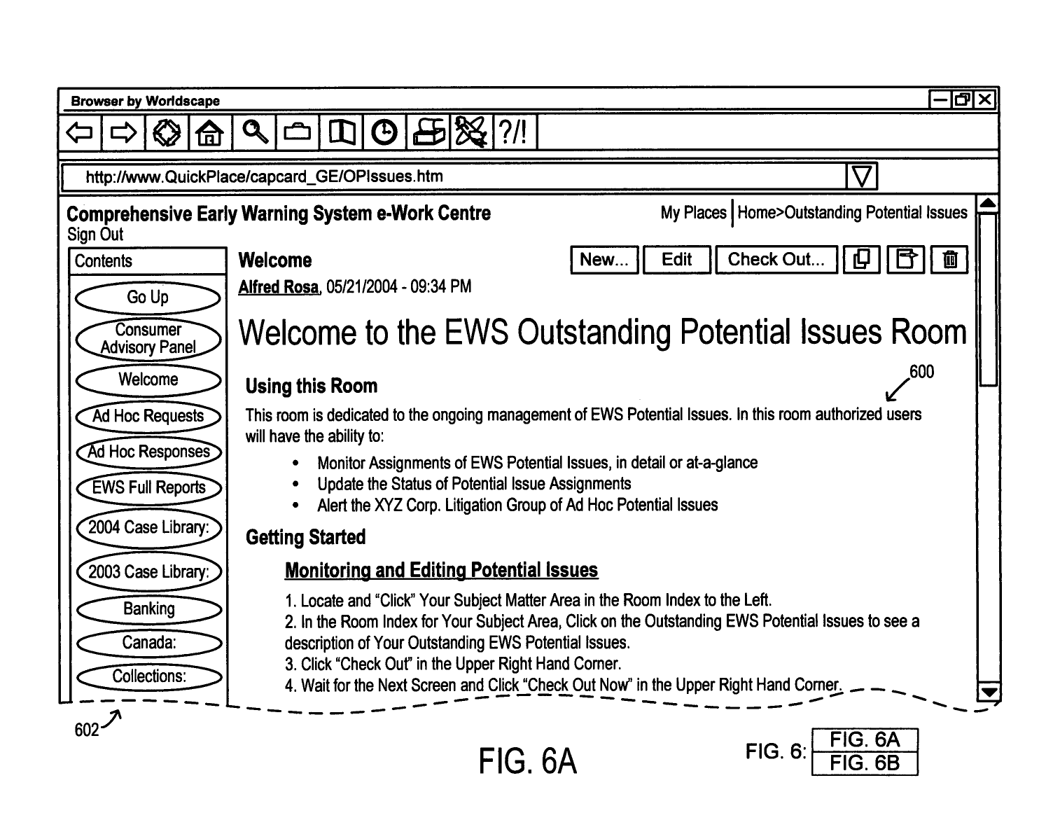

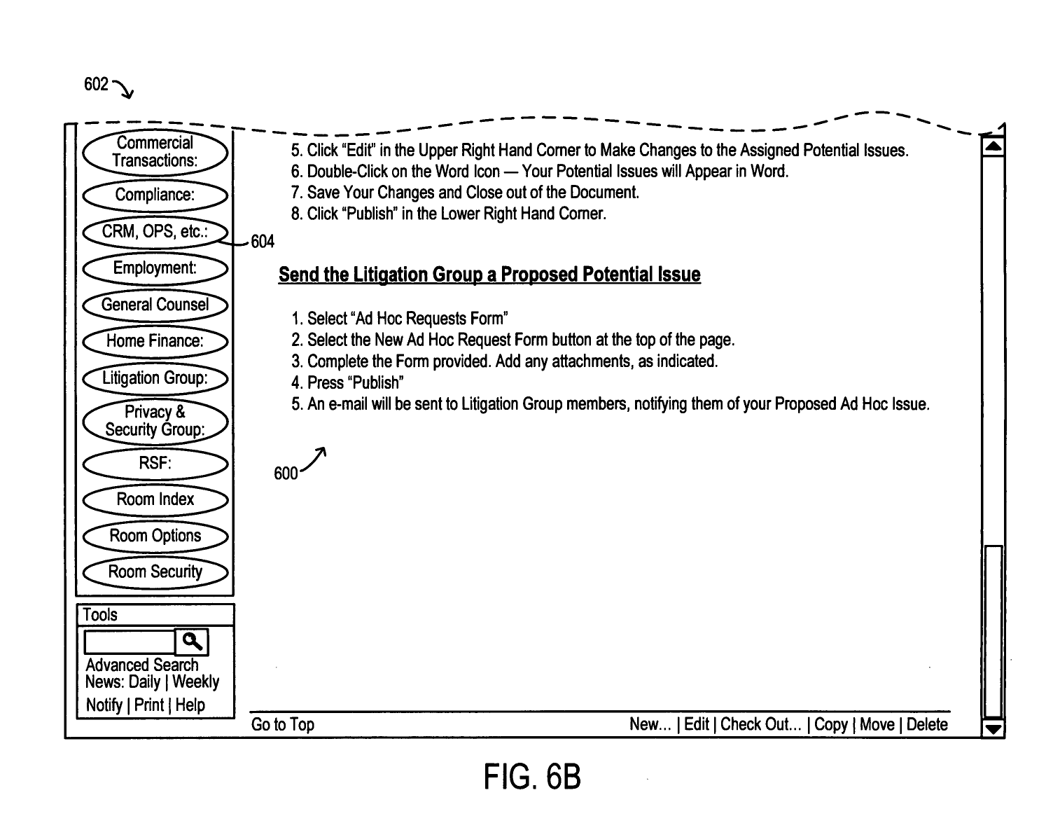

The screen display may also include, at its left-hand side, for example, a column 504 of cursor-actuatable buttons (cursor not shown). The buttons of column 504 may each provide access to a respective auxiliary function of the EWS. In addition, one of the buttons (e.g., button 506, FIG. 5A) may be actuatable by the use of the pointing device of the first user's client computer to access the screen display shown in FIG. 6 (which is made up of FIGS. 6A and 6B). The screen display of FIG. 6 corresponds to a web page or “room” known as the “potential issues room”. Activity by the first user and by the computer system 100 to accomplish navigation to the potential issues room screen display is indicated by block 406 in FIG. 4.

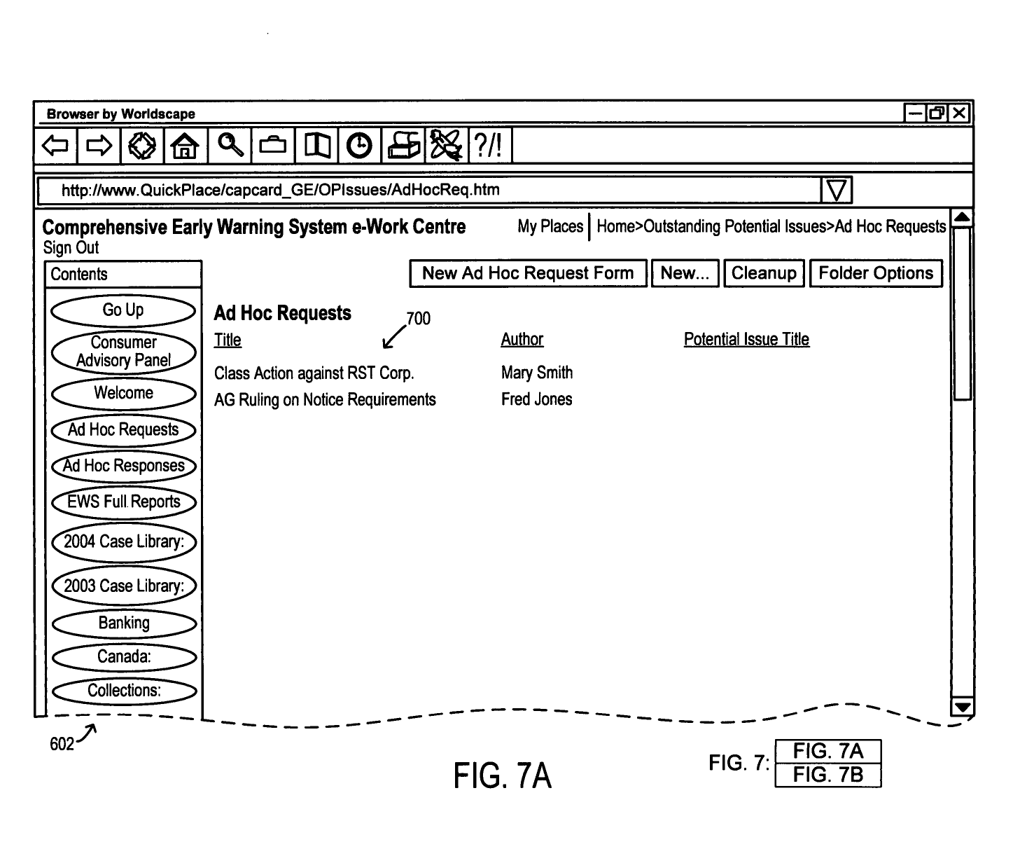

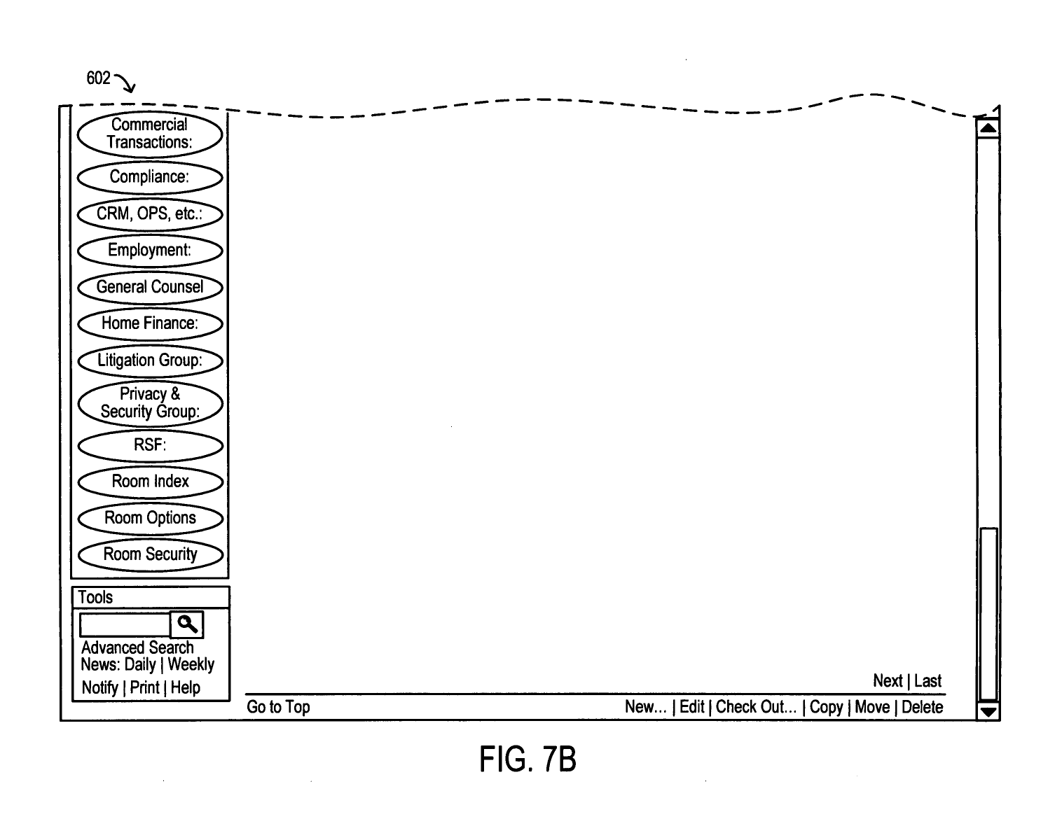

Referring again to FIG. 6, the potential issues room screen display may, for example, contain text at 600 to present instructions on how to utilize some features of the EWS. In addition, the screen display of FIG. 6 may have actuatable buttons arrayed in a column 602 at the left-hand side of the screen display. As will be understood better in view of subsequent discussion, some of the buttons in the column 602 each correspond to a respective area of responsibility within the corporation that operates the computer system 100. As will be seen, notifications of potential legal issues and responses thereto may be conveniently categorized for storage and access in accordance with the areas of responsibility to which the respective buttons correspond. In addition, one of the buttons (e.g., button 604, FIG. 6A) may be actuatable by use of the pointing device of the first user's client computer to access the screen display shown in FIG. 7 (which is made up of FIGS. 7A and 7B). The screen display of FIG. 7 corresponds to a web page or “folder” known as the “request folder”. Activity by the first user and by the computer system 100 to accomplish navigation to the request folder screen display is indicated by block 408 in FIG. 4.

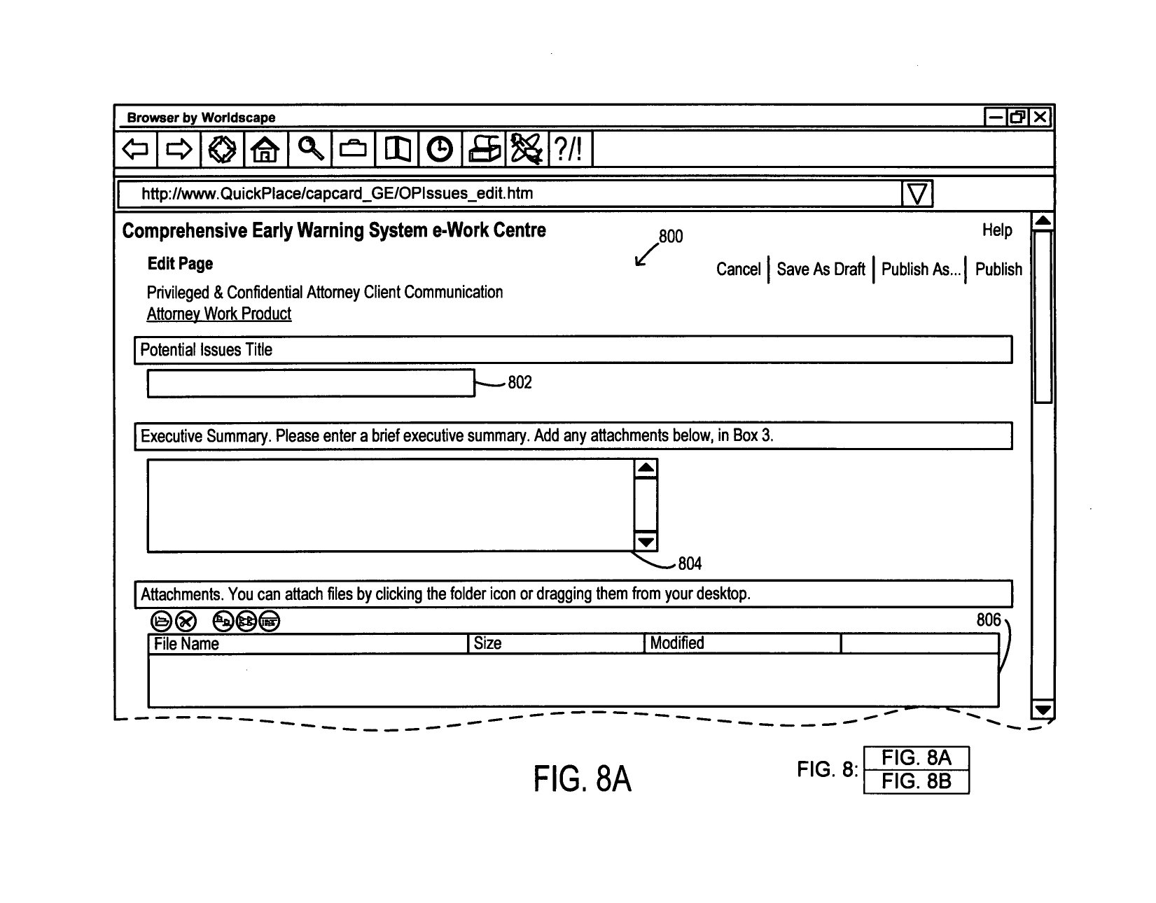

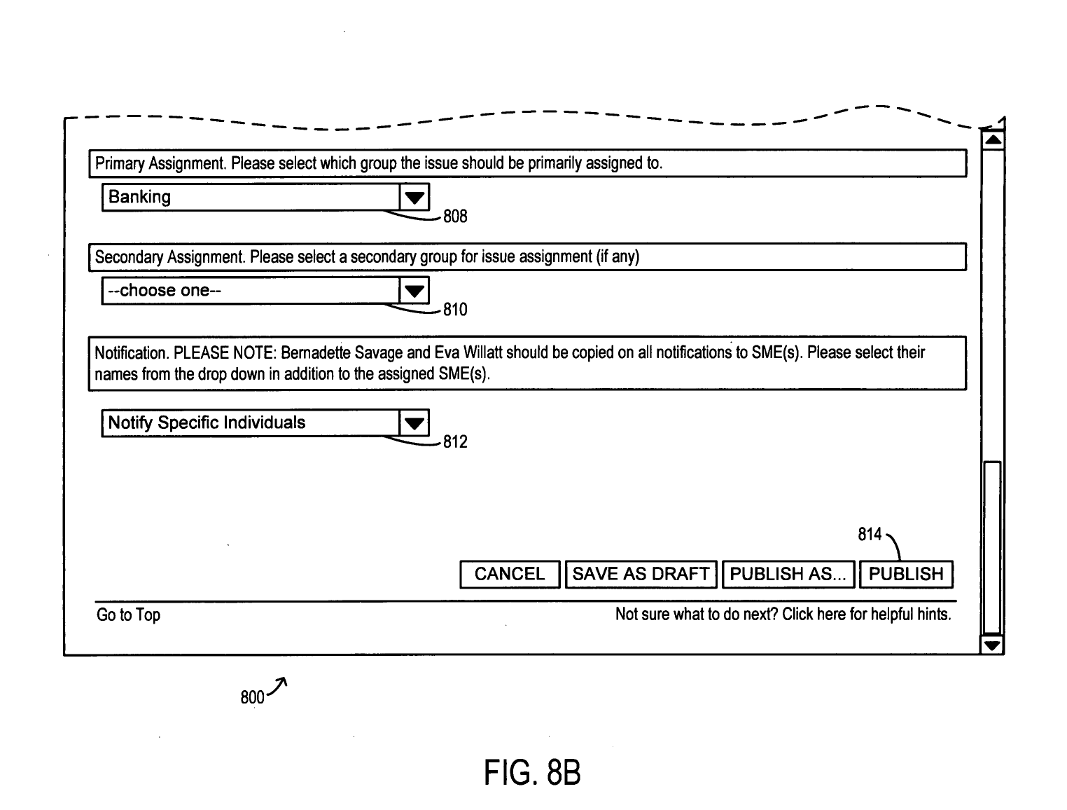

The request folder screen display may list (as indicated at 700 in FIG. 7A) one or more potential issue notifications that have been previously published in the EWS. The screen display of FIG. 7 may also have essentially the same column 602 of actuatable buttons as in the screen display of FIG. 6. In addition, near the top of the screen display of FIG. 7, or alternatively in the column 602 or elsewhere in the screen display, there may be a button 702 which is an actuatable option that may be actuatable by use of the pointing device of the first user's client computer to access the screen display shown in FIG. 8 (which is made up of FIGS. 8A and 8B). Activity by the first user and by the computer system 100 to accomplish navigation to the screen display of FIG. 8 is indicated by block 410 in FIG. 4

The screen display of FIG. 8 includes a form 800 that is completeable by the first user, by use of the pointing device and keyboard of the first user's client computer, to provide a notification of a potential legal issue. The form 800 includes a title field 802 (FIG. 8A), which the first user may fill out with text to create a title for the notification. The form 800 also includes a summary field 804 which the first user may fill out with text to provide a concise description of the potential legal issue recognized at decision block 400 (FIG. 4). Also included in the form 800 is an attachment field 806, in which the first user may append supporting documents, such as court decisions, news reports, etc., that provide background concerning the potential legal issue.

In addition, the form 800 includes a drop down menu 808 (FIG. 8B). The menu 808 is actuatable by the pointing device of the first user's client computer to select from among a number of options (only one option visible in the drawing) presented by the menu 808. Each of the options presented by the menu 808 may correspond to a respective area of responsibility within the corporation. Selection of an option causes the notification to be assigned to the corresponding area of responsibility and to be directed to a respective recipient (e.g., an attorney) who is responsible for considering legal issues that pertain to the area of responsibility. The recipient may be another user of the computer system 100.

The form 800 further includes another drop down menu 810, which may be similar to menu 808 in that menu 810 may also include options (not shown) that each correspond to a respective area of responsibility within the corporation. In addition the menu 810 includes an option that does not select an area of responsibility. Menu 810 may be actuated by the first user to select a secondary assignment of the potential issue notification, but selection of a secondary assignment is not required for completion of the form 800.

A third drop down menu 812 is also included in the form 800. The menu 812 allows the first user to select one or more additional recipients of the potential issue notification in addition to the recipient(s) who correspond(s) to the primarily assigned area of responsibility and to the secondarily assigned area of responsibility, if any.

Among other actuatable options in the form 800 is a button 814, which the first user can actuate to indicate that the form has been completed and should be published in the EWS.

Activity by the first user and by the computer system 100 to accomplish completion of the form 800 is indicated at 412 in FIG. 4. Completion of the form 800 includes filling in the text fields 802 and 804 and possibly also attaching one or more documents in the attachment field 806. In addition, the first user effectively designates at least one recipient for the notification by selecting an option from menu 808 to designate an area of responsibility. The first user may also designate a secondary assignment area of responsibility via menu 810 and may designate one or more additional recipients via menu 812. Then the first user may cause the notification to be published by actuating the “publish” button 814.

Activity by the first user and by the computer system 100 to publish the potential issue notification is indicated at 414 in FIG. 4. When the potential issue notification is published it is stored in a “room” (e.g., on a web page) that corresponds to the area of responsibility to which the issue was primarily assigned by selection of an option from menu 808 of form 800. Each user who has access to the room for that area of responsibility thus has access to the potential issue notification when the notification is published. In addition, upon publication of the notification, it is also stored in the room that corresponds to the area of responsibility, if any, to which the issue was secondarily assigned by selection of an option from menu 810 of form 800. A listing (e.g. a line of text) concerning the published notification may also now appear in the page representing the request folder, as exemplified by the screen display of FIG. 7.

Furthermore, upon publishing of the notification, an electronic mail message is automatically dispatched (as indicated at 416 in FIG. 4) by the computer system 100 to the recipient (system user) who is responsible for considering and following up on potential issues assigned to the area of responsibility selected via the menu 808. The electronic mail message indicates that the potential issue notification has been published and has been directed to the recipient who corresponds to the selected area of responsibility. The computer system 100 permits the recipient to retrieve the electronic mail message and to display it on the display device of the recipient's client computer.

If the notification is assigned to a secondary area of responsibility and/or if additional recipients are designated, an additional electronic mail message or messages may also be dispatched to the corresponding recipients.

In the meantime, the first user, having published the potential issue notification, may log off from the EWS, as indicated at 418.

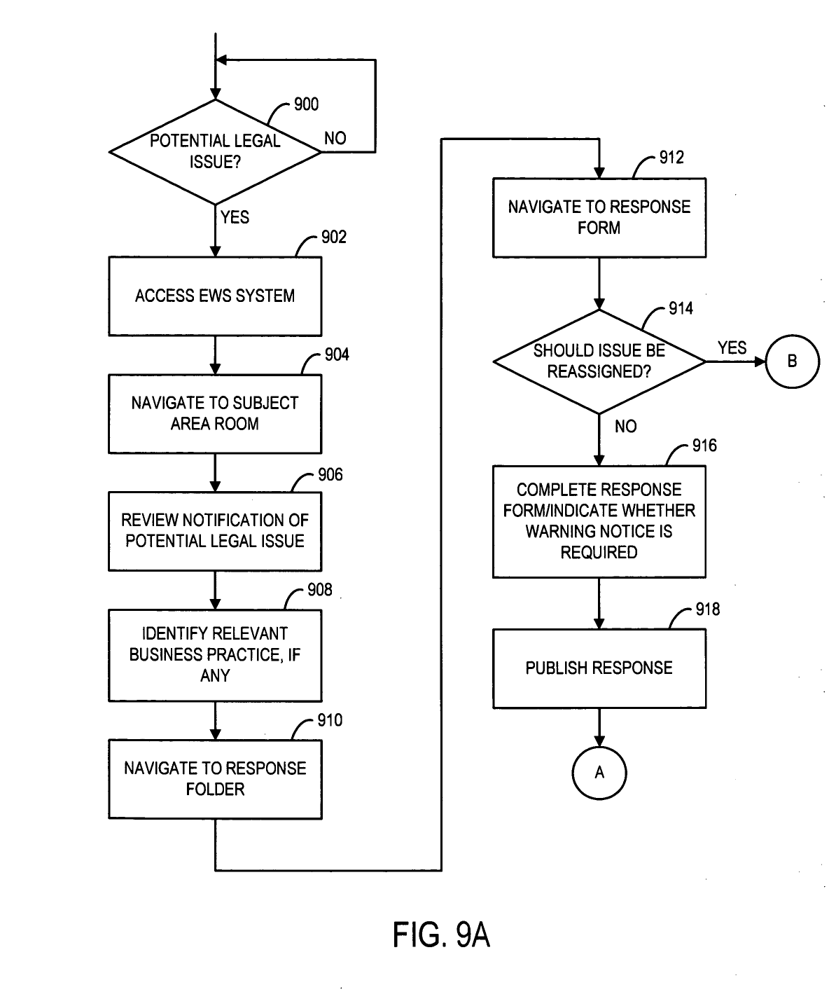

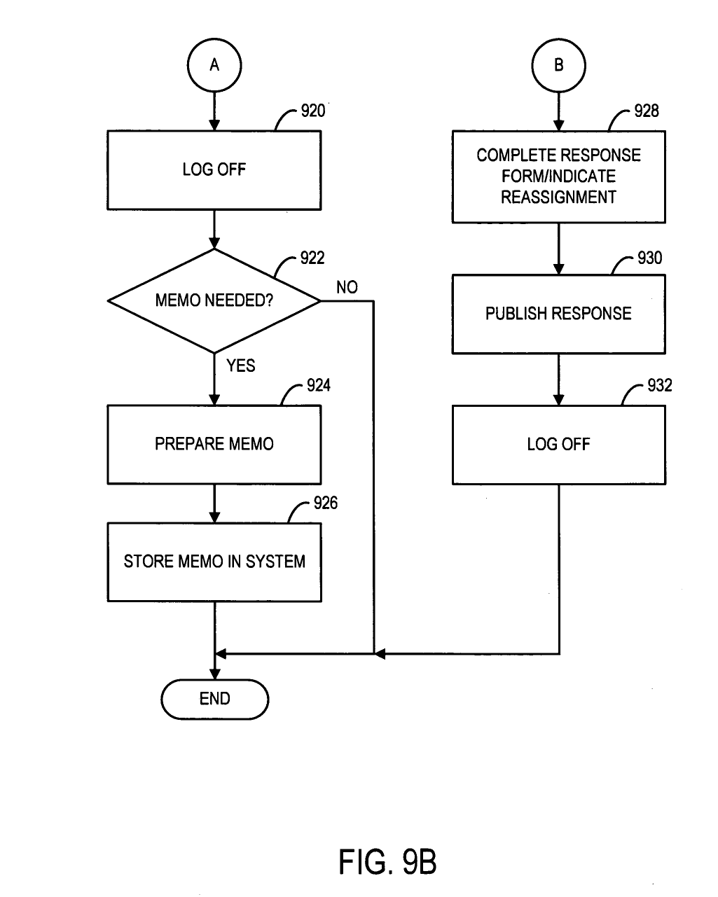

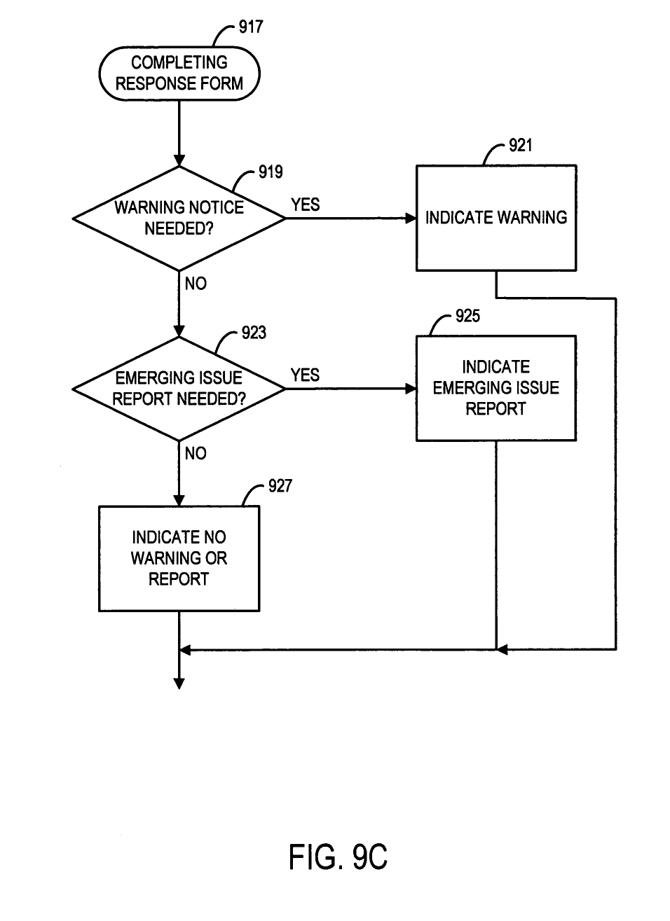

FIGS. 9A and 9B together form a flow chart that illustrates a process performed according to some embodiments to evaluate and respond to a potential legal issue for which a notification is published in the EWS by the process of FIG. 4.

At 900 in FIG. 9A is a decision block at which it is determined whether a particular user of the computer system 100 has received an e-mail message to indicate that the user (hereinafter referred to as “second user”) has been designated to receive a potential issue notification. That is, it is determined whether a new potential issue notification has been assigned/directed to the area of responsibility for which the second user is responsible.

If at 900 no such e-mail message is received, the process idles. However, if such a potential issue is received, then the second user uses a second one of the client computers to access the EWS, as indicated at 902. As before, password entry and/or other security requirements may need to be met for the second user to obtain access to the EWS.

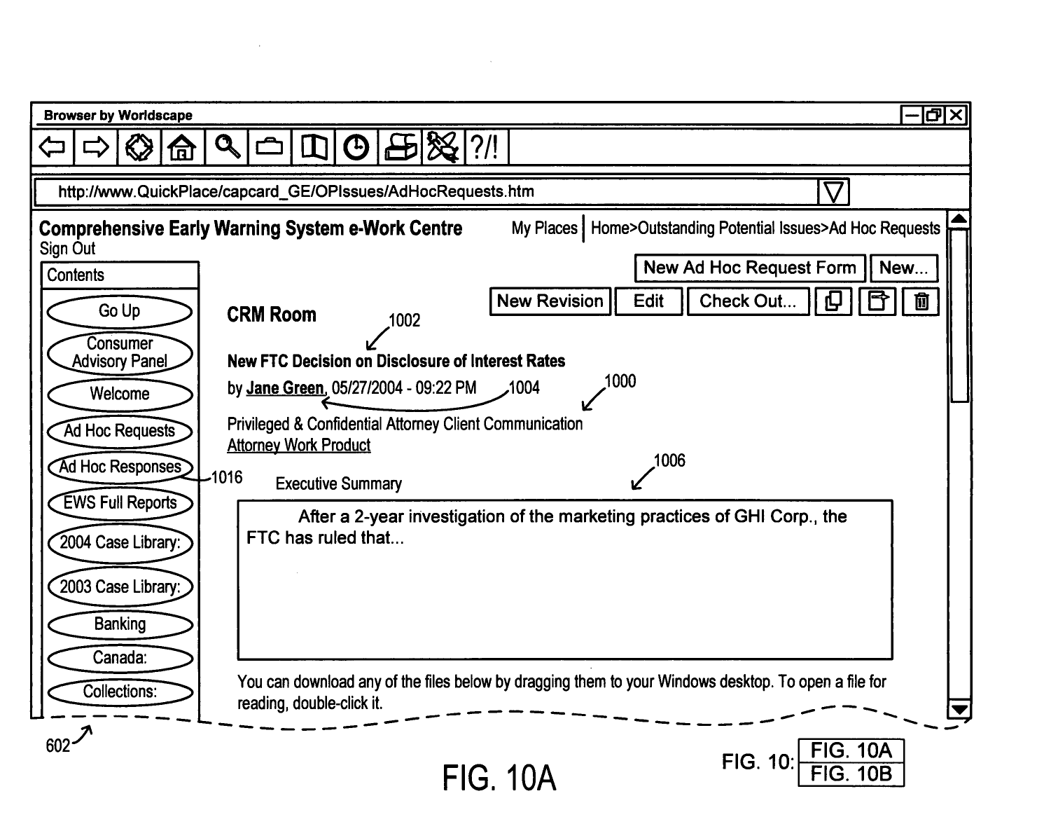

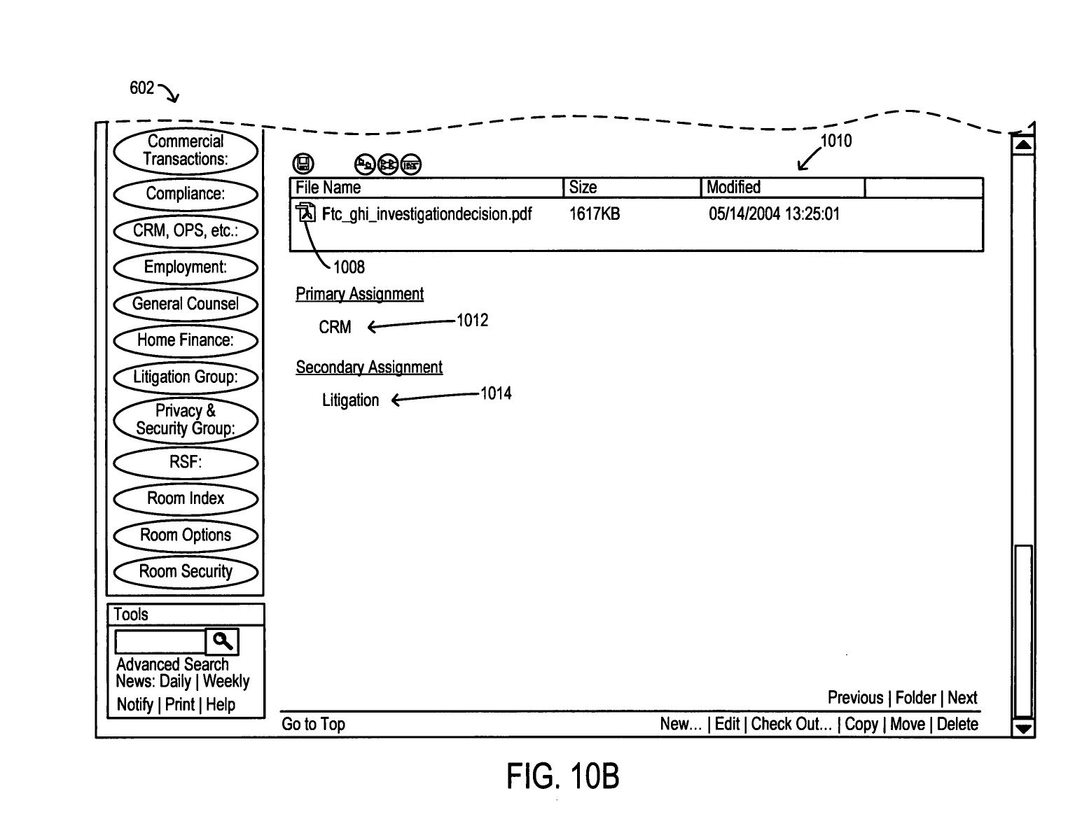

Next, as indicated at 904, the second user may navigate to the web page or “room” which corresponds to the second user's area of responsibility. More specifically, after having the welcome screen display (FIG. 5) displayed on the display device of the second user's client computer, the second user may use the pointing device of the second user's client computer to actuate button 506 (FIG. 5A). In response to the actuation of button 506, the potential issues room screen display (FIG. 6) is displayed on the display device of the second user's client computer. The second user may then actuate the button (say, in this example button 604, FIG. 6B), within the column 602, which corresponds to the second user's area of responsibility. The result is that the screen display for the corresponding “room” is next displayed on the display device of the second user's client computer. FIG. 10 (which is made up of FIGS. 10A and 10B) presents an example of a subject area room screen display.

The screen display of FIG. 10 includes a confidentiality and privilege notice, indicated at 1000 in FIG. 1A. The title of the potential issue notification as entered by the first user in the title field 802 of the form 800, is indicated at 1002 in FIG. 10A. The name of the first user (i.e., the person who authored the notification) is indicated at 1004. Text at 1006 states the summary of the potential issue, as entered by the first user in the summary field 804 of the form 800. An icon 1008 which represents a supporting document is present in attachment field 1010 of the subject area room screen display. Text at 1012 indicates the area of responsibility to which the first user primarily assigned the potential issue notification. Text at 1014 indicates the secondarily assigned area of responsibility, if any. The same column 602 of buttons as in the screen displays of FIGS. 6 and 7 may also be present in the subject area screen display shown in FIG. 10.

Thus the screen display of FIG. 10 provides to the second user information concerning the potential legal issue notification published by the first user and directed to the second user by the first user. Block 906 in FIG. 9A represents the activity of the second user in reviewing the potential issue notification, exemplified by the information conveyed by the screen display of FIG. 10. It may be assumed that the second user (typically an in-house attorney) is an expert in regard to the corporate area of responsibility to which. the notification was assigned by the first user, and that the second user is familiar with the business practices of the corporation in regard to the area of responsibility. In the case of some potential issue notifications, the second user, upon reviewing the notification, may recognize that one or more business practices of the corporation may present an exposure to litigation in view of the potential legal issue reported in the notification. Thus block 908 in FIG. 9A represents the identification by the second user of a corporate business practice to which the potential legal issue is relevant.

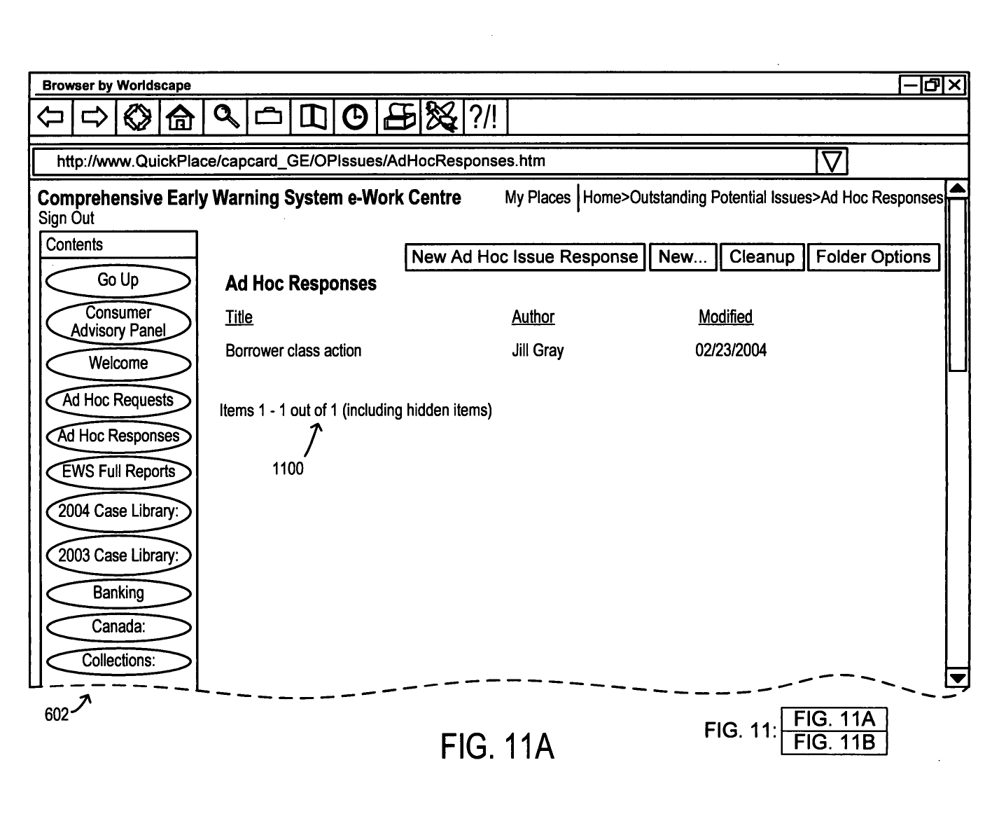

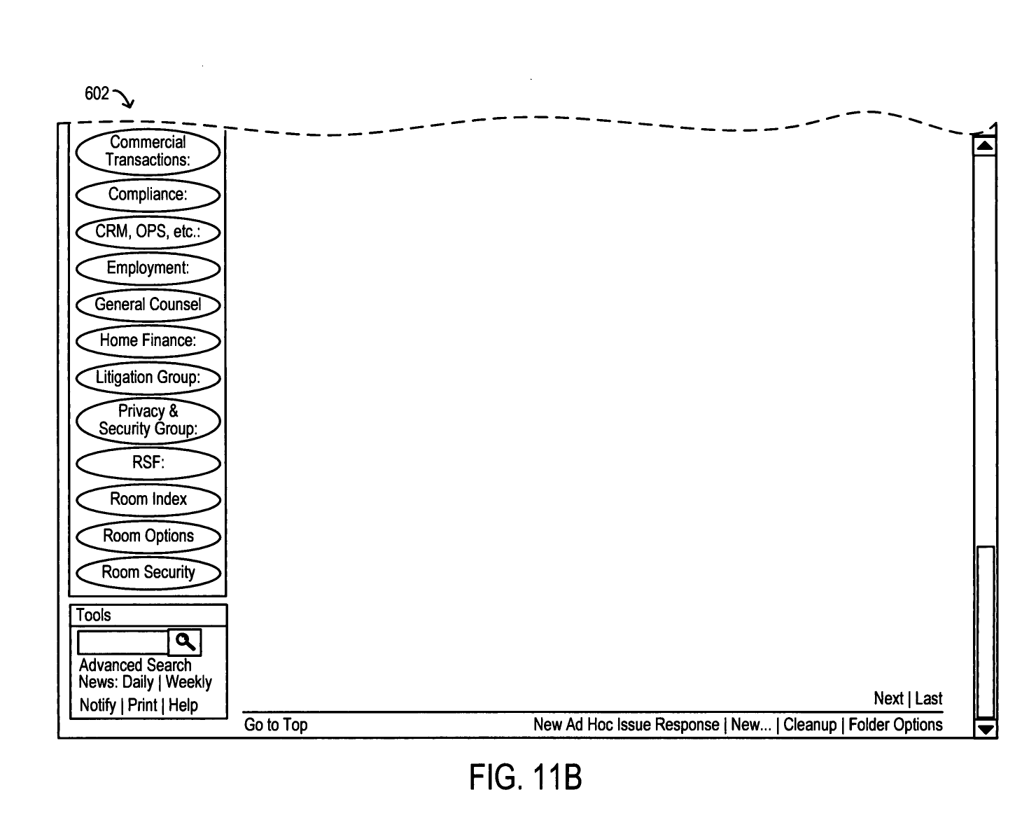

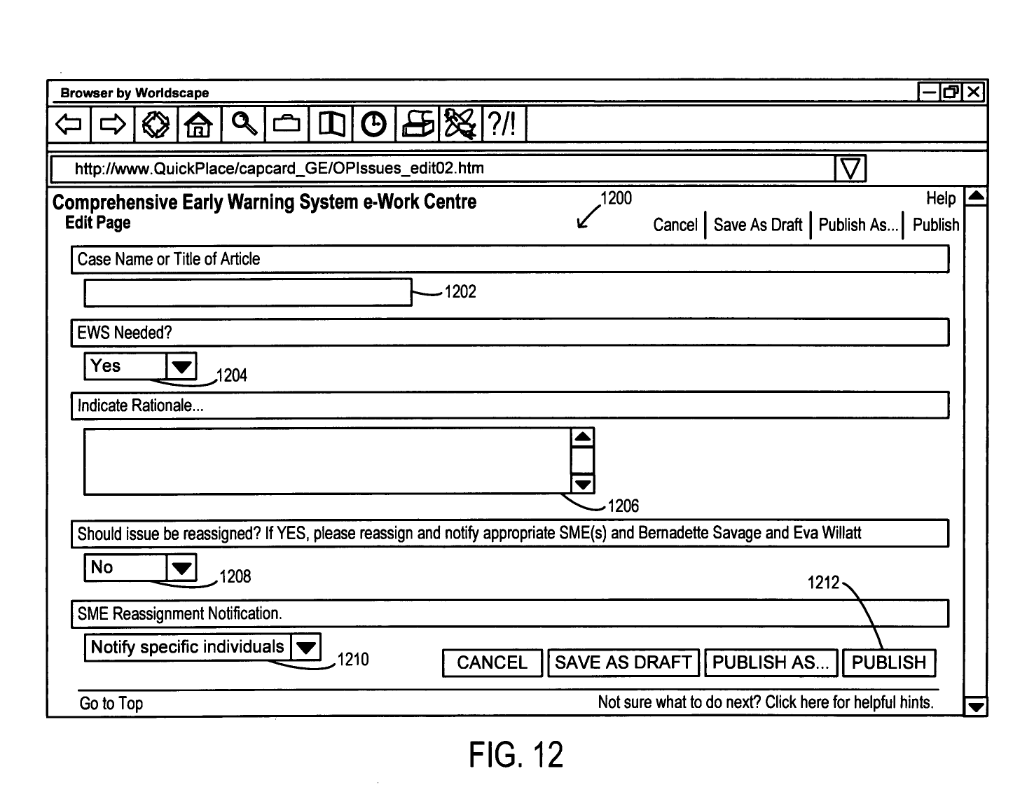

The second user may then navigate to a “response folder” screen display. Activity by the second user and by the computer system 100 to accomplish navigation to the response folder screen display is indicated by block 910 in FIG. 9A. More specifically, the second user may use the pointing device of the second user's client computer to actuate button 1016 (FIG. 10A) that is included in the subject area screen display. Upon actuation of the button 1016, the display device of the second user's client computer may display the response folder screen display, of which an example is presented in FIG. 11 (made up of FIGS. 11A and 11B). The response folder screen display may list, as indicated at 1100 in FIG. 11A, one or more responses previously published in the EWS with respect to potential issue notifications. Further, the response folder screen display may have essentially the same column 602 of actuatable buttons as in the screen display of FIG. 6. In addition, near the top of the screen display of FIG. 11, or alternatively in the column 602 or elsewhere in the screen display, there may be a button 1102 (FIG. 11A) which is an actuatable option that may be actuatable by use of the pointing device of the second user's client computer to access the screen display shown in FIG. 12. Activity by the second user and by the computer system 100 to accomplish navigation to the screen display of FIG. 12 is indicated by block 912 in FIG. 9A.

The screen display of FIG. 12 includes a form 1200 that is completeable by the second user, by use of the pointing device and keyboard of the second user's client computer, to provide a response to the potential issue notification published by the first user and directed to the second user by the first user. The form 1200 includes a title field 1202 which the second user may fill out with text to create a title to the response. The title to the response may be different from the title to the potential issue notification, since, for example, the title to the notification may focus on the potential legal issue, whereas the title to the response may focus on the business practice identified as relevant by the second user. In other cases, the response may have the same title as the notification.

The form 1200 also includes a drop down menu 1204, which is actuatable by the pointing device of the second user's client computer to select from among a number of options (only one option visible in the drawing) presented by the menu 1204. The menu 1204 may include an early warning menu option (indicated by “yes” in the drawing) which is selectable by using the pointing device of the second user's client computer to indicate that a warning notice concerning the potential legal issue and the identified business practice is to be provided to various business managers and/or in-house attorneys with responsibilities in regard to the area of responsibility to which the potential legal issue was assigned by the first user. The persons to whom the warning notice is to be directed may include one or more leading business managers of the corporation and/or one or more leading in-house attorneys of the corporation. At least some of the persons to whom the warning notice is to be directed may be users of the computer system who are different from the first and second users. The menu 1204 may include another option, which is not shown, to indicate that a warning notice is not needed.

Also included in the form 1200 is a “rationale” field 1206 which the second user may fill out with text to give the second user's reasons for either initiating a warning notice or for determining that a warning notice is not warranted. The text to be filled in to the rationale field 1206 may refer to the potential legal issue directly and/or by identifying the notification to which the second user is responding, and may also identify the one or more business practices to which the second user considered the potential legal issue to be relevant.

The form 1200 further includes another drop down menu 1208, which may be actuatable by the pointing device of the second user's client computer to indicate whether the second user elects to reassign the potential legal issue to a corporate area of responsibility that is different from the second user's area of responsibility. The second user may determine, upon reviewing the potential issue notification, that the potential legal issue is not particularly relevant to the second user's area of responsibility, but rather should be considered by the in-house attorney designated as responsible for another corporate area of responsibility. The menu 1208 is provided to allow the second user to implement this determination by the second user.

In addition, the form 1200 includes a further drop down menu 1210, which may be actuatable by the pointing device of the second user's client computer to select a corporate area of responsibility to which the potential legal issue should be reassigned. The menu 1210 may also be actuatable to select individuals who are to be notified of the reassignment of the potential legal issue.

Among other actuatable options in the form 1200 is a button 1212, which the second user can actuate to indicate that the form has been completed and should be published in the EWS.

As noted above, in some cases the second user may determine that the potential legal issue should be reassigned to another area of corporate responsibility. Decision block 914 in FIG. 9A is indicative of this determination. If the second user does not determine that the potential issue should be reassigned, then there is activity (represented by block 916 in FIG. 9A) by the second user and by the computer system 100 to accomplish completion of the form 1200. Completion of the form 1200 may include filling in the text fields 1202 and 1206. The text filled into field 1206 may identify a corporate business practice to which, in the second user's opinion, the potential legal issue is relevant. By selecting one of the options of menu 1204 (or by leaving unchanged an automatically selected default option), the second user may indicate whether a warning notice is warranted with respect to the potential legal issue and with respect to a relevant business practice, if any.

Details of a decision-making process that may be included in block 916 (FIG. 9A) are illustrated in FIG. 9C. At 917 in FIG. 9C, it is indicated that completion of the response form of FIG. 12 is being undertaken. A decision at 919 is made concerning whether an early warning notice is required. If so, an indication to this effect (block 921) is included in the response form by, e.g., selecting the appropriate option in menu 1204 (FIG. 12). If not, a decision is made at 923 as to whether a formal report should be issued so that the potential issue continues to be tracked and considered for future action.

If a positive determination is made at 923 (i.e., if it is determined that an “emerging issue report” or the like should be made, although an early warning is not warranted), then an indication to this effect (block 925, FIG. 9C) may be provided in the response form by, e.g., a suitable notation in text field 1206. If a negative determination is made at 923, then, as indicated at 927, no indication of a warning notice or an emerging issue report is made in completing the response form.

Through actuation of menu 1208 (or by leaving a default option unchanged), the second user indicates that reassignment of the potential legal issue to another area of responsibility is not required. Since no reassignment is needed, in the case now assumed, there is no need to select another area of responsibility via menu 1210.

The second user may now effect publication of the response to the notification by actuating the “publish” button 1212. Activity by the second user and by the computer system 100 to publish the second user's response to the notification is indicated at 918 in FIG. 9A. In some embodiments, a listing (e.g. one or more lines of text) is added to the response folder (exemplified by the screen display of FIG. 11) with respect to the published response. The response may also be added to the web page stored in the server computer 102 for the area of responsibility for which the second user is responsible. If the option selected (or left unchanged) in menu 1204 indicates that a warning notice is to be provided, a predetermined list of recipients may automatically receive an electronic mail notification of the issuance of the warning notice, upon publication of the response. Also, a predetermined set of follow up procedures may automatically be set in motion upon publication of a response with an indication that a warning notice is to be issued. The computer system may operate to track performance of the follow up procedures, and to provide reminders to selected users if the follow up procedures are not performed in a timely manner, as confirmed by entries into the computer system.

After publication of the response, the second user may log off from the EWS, as indicated at 920 in FIG. 9B.

Decision block 922 in FIG. 9B indicates a determination by the second user as to whether it is necessary to prepare a memorandum describing for management and for other in-house attorneys the nature of the potential legal issue and how one or more business practices of the corporation may be implicated by the potential legal issue. Typically, the second user may determine that a memorandum is needed in cases where a warning notice is needed, or if advice of the issue should be provided to management, albeit in less urgent form than a warning notice, in a case where a warning notice is not needed.

If it is determined at 922 that a memorandum is needed, then the second user (or another in-house attorney) prepares the memorandum, by using, e.g., a standard word processing program available on one of the client computers. Activity by the second user or another user and by the computer system 100 to accomplish preparation of the memorandum is indicated at 924 in FIG. 9B. The memorandum may be sent in hard copy to suitable recipients, possibly including senior management and/or senior members of the corporation's legal department. In some embodiments the memorandum itself may be the above-mentioned warning notice, and may be printed on paper of a distinctive color, such as yellow. In cases where an emerging issue report is warranted but a warning notice is not, the memorandum may be the emerging issue report and may be printed on blue paper. In other cases, where neither a warning notice or an emerging issue report is warranted, but some further attention is needed, the second user may informally contact (e.g., by telephone) a member of management to inform him or her about the potential issue.

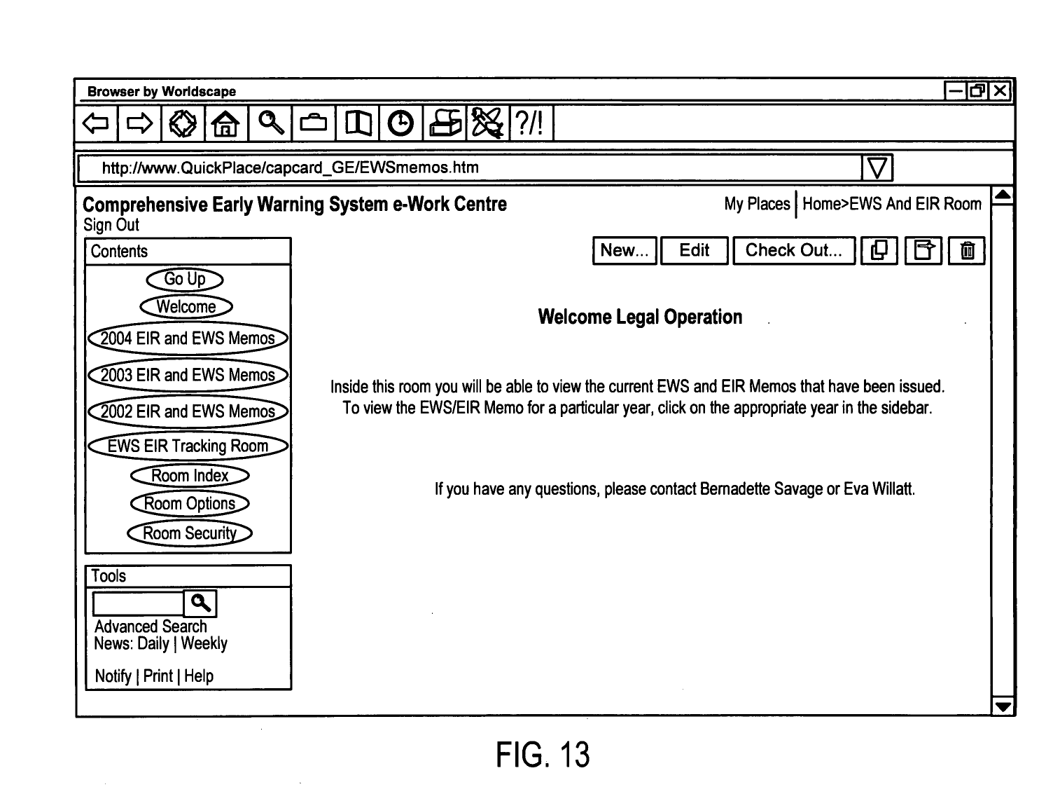

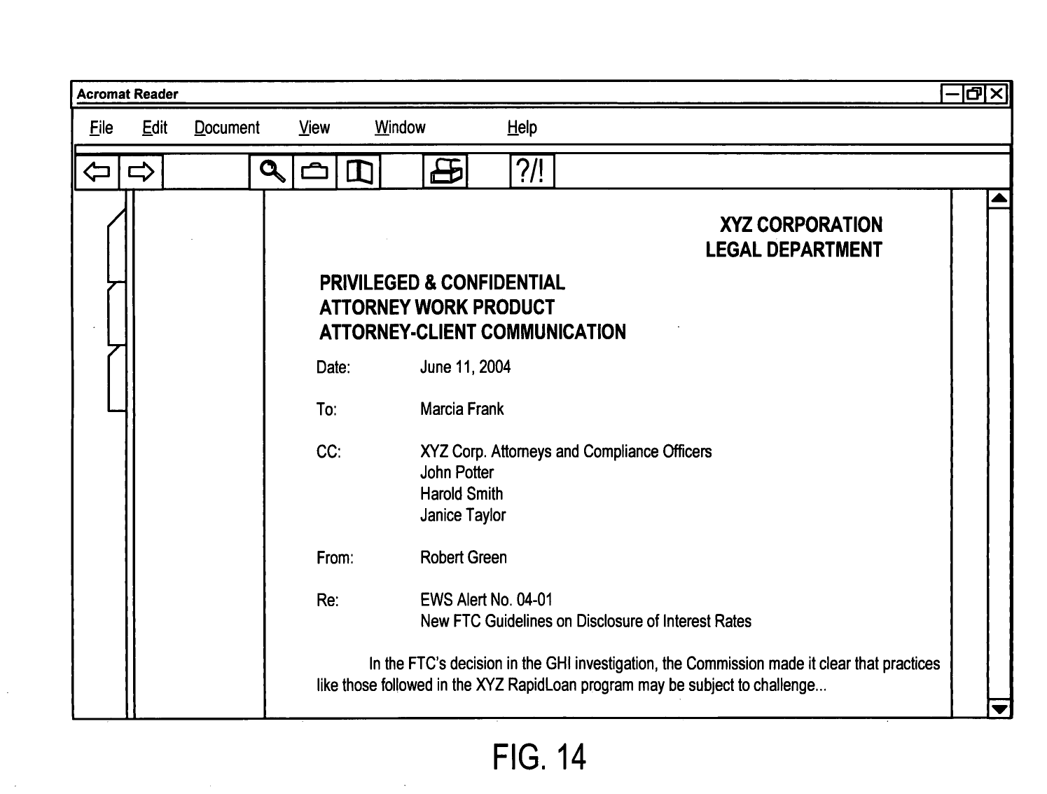

The memorandum produced at 924 may also be stored in the EWS, as indicated by block 926 in FIG. 9B. In one embodiment, the author of the memorandum may provide an electronic copy of the memorandum (e.g., on a floppy disk, which is not shown) to an administrator of the EWS. The administrator may access the EWS, arriving at the welcome screen shown in FIG. 5. The administrator may then actuate a button 508 (FIG. 5A) to navigate to a main memorandum room (e.g. a room designated EWS and EIR (Emerging Issue Report) room), exemplified by the screen display shown in FIG. 13. Through one or more actuatable options that are not explicitly shown, the administrator causes the computer system to store the memorandum in association with a suitable web page, such as a page which lists EWS-related memoranda for the current year. Users entitled to suitable access may then access the electronic copy of the memorandum so as to view the memorandum on the display devices of the users' client computers. Navigation to view the memorandum may proceed through the welcome screen (FIG. 5) and the EWS/EIR room (FIG. 13) and possibly through one or more intermediate screens (not shown, may include a screen which lists memoranda issued in a given year). A screen display in which an example memorandum is viewed is illustrated in FIG. 14.

Referring again to FIG. 9A, consideration will now be given again to the determination made at decision block 914, and particularly to the case in which the second user determines that the potential issue directed to the second user by the first user should be reassigned. In such a case, the process of FIG. 9 branches from decision block 914 to block 928, which represents activity by the second user and by the computer system 100 to accomplish completing of the form 1200 for the purpose of reassigning the notification to another area of responsibility (i.e., to another recipient who is another user of the computer system). If need be the second user may fill in the text fields 1202 and 1206 in form 1200 (FIG. 12). Also, the second user actuates menu 1208 using the pointing device of the second user's computer to indicate that the notification is to be reassigned, and actuates menu 1210 using the pointing device of the second user's computer to select at least one other area of responsibility to which the notification is to be reassigned.

The second user may then publish the response by actuating the “publish” button 1212 so that the reassignment of the notification is implemented. Activity by the second user and by the computer system 100 to publish the response and thus to reassign the notification is represented by block 930 in FIG. 9B. Upon publishing the response with selection of the reassignment option (not shown, indicated by “yes” for example) in menu 1208, an electronic mail message or other suitable notification may be provided to the selected recipient or recipients. One such recipient may be an in-house attorney who has responsibility for the corporate area of responsibility to which the potential issue notification was reassigned by the second user. Publishing of the response with the reassignment option of menu 1208 selected may also cause the potential issue notification to be stored in the room/web page that corresponds to the area of responsibility and recipient to which the potential issue notification was reassigned.

Following the completion of the form 1200 per block 928 and publishing of the response/reassignment of potential issue notification per block 930, the second user may log off the EWS, as indicated at 932 in FIG. 9B.

An early warning system such as that described herein has been effectively deployed to surface and evaluate potential legal issues, to identify business practices that may require modification or termination, and to track and manage remedial activities so that a corporation may take timely action to avoid or reduce exposure to legal risks. The efficient and focused handling of key information as provided by the EWS may lead to savings of literally millions of dollars by foreseeing and forestalling potential litigation.

In the foregoing discussion, attention has been given primarily only to one of the rooms/web pages dedicated to particular areas of responsibility within the corporation which operates the computer system. However, in practice the computer system is likely to operate such that a number of different subject area room screen displays, each corresponding to a respective area of responsibility with the corporation, are displayed on the respective display devices of various ones of the client computers at various times. Each of the subject area room screen displays may display at least one line of information concerning a potential legal issue that has been assigned to the area of responsibility to which the subject area room corresponds.

In the example screen displays illustrated in the accompanying drawings, certain buttons of the column 602 (FIGS. 6, 7,10 and 11) indicate areas of responsibility that may be assigned in, for example, a financial services company. However, other sets of buttons, suitable for use in other corporations or other types of corporations, may be used instead of the subject area buttons shown in column 602.

The server computer described herein may be constituted by one computer or by two or more computers that are linked together.

In some embodiments, the screen displays and other aspects of the EWS as described above may be authored using a conventional software package such as the “QuickPlace” software (also known as “Lotus Team Workplace”) available from IBM Lotus.

The present invention has the technical effect of using a computer system to facilitate and improve communication, assignment and tracking of potential legal issues within a corporation.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer system comprising:
a server computer;
a plurality of client computers, each of the client computers including a respective display device, a respective pointing device and a respective keyboard; and
a communication network coupled to the server computer and to the client computers to permit data communication among the server computer and the client computers;
wherein the server computer and the client computers are programmed such that:
(a) a first user at a first one of the client computers is permitted to use the respective pointing device of the first one of the client computers to actuate a first actuatable option on a first screen display to access a second screen display, the second screen display comprising a first form that is completeable by the first user to provide a notification of a potential legal issue, the first form including a first menu that is actuatable by the respective pointing device of the first one of the client computers to select from among a plurality of options presented by the first menu, each of the plurality of options corresponding to a respective potential recipient of the notification of the potential legal issue;
(b) upon the first user electing to publish the notification of the potential legal issue, an electronic mail message is automatically dispatched to the respective potential recipient who corresponds to a one of the plurality of options selected by the first user in completing the form, the respective potential recipient being a second user;
(c) the second user is permitted to retrieve the electronic mail message and to display the retrieved electronic mail message on the respective display device of a second one of the client computers, the displayed electronic mail message indicating to the second user that the notification has been published and that the notification has been directed to the second user;
(d) the second user is permitted to use the respective pointing device of the second one of the client computers to actuate a second actuatable option on at least one of the first screen display and a third screen display to access a fourth screen display, the fourth screen display for providing to the second user information concerning the potential legal issue as to which the first user provided notification; and
(e) the second user is permitted to use the respective pointing device of the second one of the client computers to actuate a third actuatable option on at least one of the first screen display and a fifth screen display to access a sixth screen display, the sixth screen display comprising a second form to provide a response to the notification of the potential legal issue provided by the first user, the second form including a second menu that includes an early warning menu option selectable by using the respective pointing device of the second one of the client computers to indicate that a warning notice concerning the potential legal issue is to be provided to a plurality of users other than the first and second users.

2. The computer system of claim 1, wherein the second form includes a field in which the second user identifies a business practice to which the potential legal issue is relevant.

3. The computer system of claim 1, wherein the server computer and the client computers are further programmed such that:
(f) upon the first user publishing the notification of the potential legal issue, at least one line of information concerning the potential legal issue is added to the first screen display; and
(g) upon the second user publishing the response to the notification, at least one line of information concerning the response is added to the fifth screen display.

4. The computer system of claim 3, wherein the server computer and the client computers are further programmed such that:
(h) at least one of the client computers displays to at least one user of the system a seventh screen display from which said at least one user is permitted to access at least one memorandum concerning the potential legal issue, said at least one memorandum stored in the computer system.

5. The computer system of claim 1, wherein:
the first menu is a first drop down menu actuatable by the respective pointing device of the first one of the client computers to display said plurality of options presented by the first menu; and
the second menu is a second drop down menu actuatable by the respective pointing device of the second one of the client computers to display a plurality of options presented by the second menu, the plurality of options presented by the second menu including said early warning option and a second option to indicate that a warning notice concerning the potential legal issue is not needed.

6. The computer system of claim 1, wherein the second actuatable option is an actuatable button among a plurality of actuatable buttons arrayed in a column at a left-hand side of at least one of the first screen display and the third screen display, at least some of the actuatable buttons of said column each corresponding to a respective area of responsibility of a plurality of areas of responsibility within a corporation which operates said computer system.

7. The computer system of claim 6, wherein said column of actuatable buttons is displayed at a left-hand side at each of the first, third, fourth and fifth screen displays.

8. A computer system comprising:
a server computer;
a plurality of client computers, each of the client computers including a respective display device, a respective pointing device and a respective keyboard; and
a communication network coupled to the server computer and to the client computers to permit data communication among the server computer and the client computers;
wherein the server computer and the client computers are programmed such that at least some of the client computers display, in response to respective requests from users, at least the following screen displays:
(a) a welcome screen display that includes a confidentiality and privilege notice and which provides an overview of an early warning system for potential legal issues;
(b) a potential issues room screen display that allows a user access to other screen displays which provide information concerning potential legal issues;
(c) a request folder screen display that lists at least one notification of a potential legal issue;
(d) a request form screen display that is completeable by using at least one of a keyboard and a pointing device to publish a notification of a potential legal issue;
(e) a plurality of subject area room screen displays, each corresponding to a respective area of responsibility within a corporation that operates the computer system and each displaying at least one line of information concerning a potential legal issue related to the respective area of responsibility;
(f) a response folder screen display that lists at least one response to a notification of a potential legal issue; and
(g) a response form screen display that is completeable by using at least one of a keyboard and a pointing device to publish a response to a notification of a potential legal issue.

9. The computer system of claim 8, wherein:
the request form screen display includes a first drop down menu actuatable by at least one of the respective pointing devices of the client computers to display a plurality of first options each corresponding to a respective one of said areas of responsibility; and
the response form screen display includes a second drop down menu actuatable by at least one of the respective pointing devices of the client computers to display a plurality of second options which include an early warning option selectable by said at least one of the respective pointing devices to indicate that a warning notice is to be provided to a plurality of users of the computer system, said warning notice identifying a potential legal issue and a business practice to which the potential legal issue is relevant.

10. The computer system of claim 9, wherein, upon publishing of a notification of a potential legal issue, an electronic mail message is automatically sent to a recipient who corresponds to a one of said first options selected by a user who published said notification.

11. The computer system of claim 8, wherein at least some of said screen displays include a plurality of actuatable buttons arrayed in a column at a left-hand side of the respective screen display, at least some of the actuatable buttons of said column each corresponding to a respective one of said areas of responsibility.

12. The computer system of claim 11, wherein said column of actuatable buttons is included in each one of: (i) the potential issues room screen display; (ii) the request folder screen display; and (iii) the response folder screen display.

13. A method of operating a computer system, the method comprising:
navigating from a first screen display to a second screen display, said second screen display including a first form that is completeable by a first user of the computer system to provide a notification of a potential legal issue, the first form including a first menu that is actuatable by a pointing device to select among a plurality of options presented by the first menu, each of the plurality of options corresponding to a respective potential recipient of the notification of the potential legal issue;
publishing the notification of the potential legal issue to at least one other user of the computer system;
in response to publishing the notification, automatically sending an electronic mail message to a second user of the computer system, the second user being the respective potential recipient who corresponds to a one of the plurality of options selected by the first user in completing said first form.

14. The method of claim 13, further comprising:
the second user accessing the published notification.

15. The method of claim 14, further comprising:
the second user navigating to a third screen display from one of a fourth screen display and the first screen display, the third screen display including a second form that is completeable by the second user to provide a response to the published notification.

16. The method of claim 15, further comprising:
the second user entering into said second form information which identifies a business practice which is relevant to a potential legal issue that is a subject of the published notification.

17. The method of claim 16, wherein the second form includes a second menu that is actuatable by a pointing device to select among a plurality of options that includes an early warning option to indicate that a warning notice concerning the potential legal issue is to be provided to a plurality of users of the computer system other than said first and second users.

18. The method of claim 17, further comprising:
in response to publishing the notification, storing the notification at a web page associated with the second user;
and wherein the second user accessing the published notification includes the second user accessing the web page associated with the second user.

19. The method of claim 15, further comprising:
the second user using the second form to indicate reassignment of the published notification to a third user.

20. The method of claim 14, further comprising:
in response to publishing the notification, storing the notification at a web page associated with the second user;
and wherein the second user accessing the published notification includes the second user accessing the web page associated with the second user.

21. A method of operating a computer system, the method comprising:
navigating from a first screen display to a second screen display, said second screen display including a first form that is completeable by a first user of the computer system to provide a notification of a potential legal issue, the first form including a first menu that is actuatable by a pointing device to select among a plurality of options presented by the first menu, each of the plurality of options corresponding to a respective potential recipient of the notification of the potential legal issue;
publishing the notification of a potential legal issue to at least one other user of the computer system;
in response to publishing the notification, storing the notification at a web page associated with the second user; and
the second user accessing the web page associated with the second user to access the published notification.

22. The method of claim 21, further comprising:
the second user navigating to a third screen display from one of a fourth screen display and the first screen display, the third screen display including a second form that is completeable by the second user to provide a response to the published notification; and
the second user entering into said second form information which identifies a business practice which is relevant to a potential legal issue that is a subject of the published notification.

23. The method of claim 22, wherein the second form includes a second menu that is actuatable by a pointing device to select among a plurality of options that includes an early warning option to indicate that a warning notice concerning the potential legal issue is to be provided to a plurality of users of the computer system other than said first and second users.

24. A method of operating a computer system, the method comprising:
(a) displaying on at least one display device of the computer system a welcome screen display that includes a confidentiality and privilege notice and which provides an overview of an early warning system for potential legal issues;
(b) displaying on at least one display device of the computer system a potential issues room screen display that allows a user access to other screen displays which provide information concerning potential legal issues;
(c) displaying on at least one display device of the computer system a request folder screen display that lists at least one notification of a potential legal issue;
(d) displaying on at least one display device of the computer system a request form screen display that is completeable by using at least one of a keyboard and a pointing device to publish a notification of a potential legal issue;
(e) displaying a plurality of subject area room screen displays, each corresponding to a respective area of responsibility within a corporation that operates the computer system and each displaying at least one line of information concerning a potential legal issue related to the respective area of responsibility, each of the plurality of subject area room screen displays being displayed from time to time on at least a respective display device of the computer system;
(f) displaying on at least one display device of the computer system a response folder screen display that lists at least one response to a notification of a potential legal issue; and
(g) displaying on at least one display device of the computer system a response form screen display that is completeable by using at least one of a keyboard and a pointing device to publish a response to a notification of a potential legal issue.

25. The method of claim 24, wherein:
the request form screen display includes a first drop down menu actuatable by a pointing device to display a plurality of first options each corresponding to a respective one of said areas of responsibility; and
the response form screen display includes a second drop down menu actuatable by a pointing device to display a plurality of second options which include an early warning option selectable to indicate that a warning notice is to be provided to a plurality of users of the computer system, said warning notice identifying a potential legal issue and a business practice to which the potential legal issue is relevant.

26. The method of claim 25, further comprising:
publishing a notification of a potential legal issue; and
in response to the publishing, automatically sending an electronic mail message to a recipient who corresponds to a one of said first options selected by a user who published said notification.

27. The method of claim 24, wherein at least some of said screen displays include a plurality of actuatable buttons arrayed in a column at a left-hand side of the respective screen display, at least some of the actuatable buttons of said column each corresponding to a respective one of the areas of responsibility.

28. The method of claim 27, wherein said column of actuatable buttons is included in each one of: (i) the potential issues room screen display; (ii) the request folder screen display; and (iii) the response folder screen display.
